(19) United States
(12) Patent Application Publication
(10) Pub. No.: US 2023/0070569 A1
(43) Pub. Date: Mar. 9, 2023

(54) LEAD MEMBER, PACKAGE OF SECONDARY BATTERY, AND METHOD FOR PRODUCING LEAD MEMBER

(71) Applicant: SUMITOMO ELECTRIC INDUSTRIES, LTD., Osaka (JP)

(72) Inventors: Nozomi ONAKA, Tochigi (JP); Tomoyuki OKADA, Tochigi (JP); Kazuto SHIINA, Tochigi (JP)

(21) Appl. No.: 17/759,762

(22) PCT Filed: Nov. 27, 2020
(86) PCT No.: PCT/JP2020/044336

§ 371 Date: Jul. 29, 2022

(30) Foreign Application Priority Data
Feb. 17, 2020 (JP) 2020-024013

(51) Int. Cl. H01M 50/562; H01M 50/557; H01M 50/178; H01M 50/105; B32B 3/08; B32B 27/32

(52) U.S. Cl. CPC H01M 50/562; H01M 50/557; H01M 50/178; H01M 50/105; B32B 3/08; B32B 27/32; B32B 15/20

(57) ABSTRACT

A lead member for a secondary battery includes a conductor, and a covering material. The conductor has an upper surface and a lower surface that extend in a length direction and a width direction and are opposite to each other, and a first side surface and a second side surface that extend in the length direction and a thickness direction, connect the upper surface to the lower surface, and are opposite to each other. The covering material is formed by sticking a plurality of insulating films together to surround the upper surface, the first side surface, the lower surface, and the second side surface. Each of the plurality of insulating films includes an inner layer and an outer layer, in an order from a side closer to the conductor. The lead member includes a first insulator and a second insulator on the first side surface and the second side surface of the conductor respectively, in an area surrounded by the covering material of the conductor. The first insulator and the second insulator have a lower melting point than the inner layer. The first insulator and the second insulator are placed to be separated from each other.

### TECHNICAL FIELD

This application is based upon and claims priority to Japanese Patent Application No. 2020-024013, filed Feb. 17, 2020, the entire contents of which are incorporated herein by reference.

The present disclosure relates to a lead member, a package of a secondary battery, and a method for manufacturing the lead member.

### BACKGROUND ART

A body of a secondary battery is accommodated and packaged in an enclosing casing and is used. Such a secondary battery package includes a lead member. The lead member is used to lead the terminals of the positive and negative electrodes of the secondary battery body accommodated in the enclosing casing to the outside of the enclosing casing. The lead member is configured such that an insulating film is bonded to a portion of a conductor to cover the periphery of the conductor.

In such a lead member, one end of the conductor is electrically connected to one electrode, and the other end of the conductor is led out from the enclosing casing, thereby allowing electrical connection with the electrode via the lead member (for example, Patent Document 1).

### RELATED ART DOCUMENTS

### Patent Documents

[Patent Document 1] Japanese Laid-Open Patent Application Publication No. 2018-163896
[Patent Document 2] Japanese Laid-Open Patent Application Publication No. 2017-117705

### SUMMARY OF THE INVENTION

In the present disclosure, a lead member for a secondary battery, including a conductor, and a covering material, is provided. The conductor has an upper surface and a lower surface that extend in a length direction and a width direction and are opposite to each other, and a first side surface and a second side surface that extend in the length direction and a thickness direction, connect the upper surface to the lower surface, and are opposite to each other. The covering material is formed by sticking a plurality of insulating films together to surround the upper surface, the first side surface, the lower surface, and the second side surface. Each of the plurality of insulating films includes an inner layer and an outer layer, in an order from a side closer to the conductor. The lead member includes a first insulator and a second insulator on the first side surface and the second side surface of the conductor respectively, in an area surrounded by the covering material of the conductor. The first insulator and the second insulator have a lower melting point than the inner layer. The first insulator and the second insulator are placed to be separated from each other.

Additionally, in the present disclosure, a method of manufacturing a lead member for a secondary battery is provided. The method includes:

a) a step of preparing a conductor having a first surface and a second surface that are opposite to each other, and a third surface and a fourth surface that are opposite to each other and are orthogonal to the first surface and the second surface;

b) a step of placing insulator materials on a portion of the first surface and a portion of the second surface, the insulator material having an insulating property;

c) a step of placing a first insulating film including a first inner layer and a first outer layer to cover the insulator materials when viewed from the third surface such that the first inner layer faces the third surface;

d) a step of placing a second insulating film including a second inner layer and a second outer layer to cover the insulator materials when viewed from the fourth surface such that the second inner layer faces the fourth surface; and

e) a step of welding the first insulating film and the second insulating film to each other on a first surface side and on a second surface side.

Additionally, in the present disclosure, a method of manufacturing a lead member for a secondary battery is provided. The method includes:

a) a step of preparing a first insulating film including a first inner layer and a first outer layer, and a second insulating film including a second inner layer and a second outer layer;

b) a step of placing first insulator materials on portions of the first inner layer in the first insulating film;

c) a step of preparing a conductor having a first surface and a second surface that are opposite to each other, and a third surface and a fourth surface that are opposite to each other and are orthogonal to the first surface and the second surface;

d) a step of placing the first insulating film such that the first inner layer faces the third surface of the conductor when viewed from the third surface, the first insulator materials being placed on a portion of the first surface of the conductor and a portion of the second surface of the conductor;

e) a step of placing the second insulating film such that the second inner layer faces the fourth surface of the conductor when viewed from the fourth surface; and

f) a step of welding the first insulating film and the second insulating film to each other on a first surface side and on a second surface side.

### BRIEF DESCRIPTION OF THE DRAWINGS

FIG. 1 is a cross-sectional view schematically illustrating a configuration of a lead member for a conventional secondary battery.

FIG. 2 is a top view schematically illustrating a configuration of a lead member for a secondary battery according to one embodiment of the present disclosure.

FIG. 3 is a drawing schematically illustrating a cross-section along the I-I line of the lead member for the secondary battery according to one embodiment of the present disclosure illustrated in FIG. 2.

FIG. 4 is a perspective view schematically illustrating a configuration example of a package of the secondary battery including the lead member according to one embodiment of the present disclosure.

FIG. 5 is a drawing schematically illustrating a cross-section along the line II-II of the package of the secondary cell illustrated in FIG. 4.

FIG. 6 is drawing schematically illustrating an example of a flow of a method of manufacturing the lead member according to one embodiment of the present disclosure.

FIG. 7 is a top view schematically illustrating a conductor used in the method of manufacturing the lead member according to one embodiment of the present disclosure.

FIG. 8 is a drawing schematically illustrating a cross-section along the III-III line of the conductor illustrated in FIG. 7.

FIG. 9 is a top view schematically illustrating assembly used in the method of manufacturing the lead member according to one embodiment of the present disclosure.

FIG. 10 is a drawing schematically illustrating a cross-section along the IV-IV line of the assembly illustrated in FIG. 9.

FIG. 11 is a cross-sectional view schematically illustrating a configuration of a lead member manufactured in the method of manufacturing the lead member according to one embodiment of the present disclosure.

FIG. 12 is a drawing schematically illustrating a flow of a method of manufacturing a lead member according to another embodiment of the present disclosure.

FIG. 13 is a drawing schematically illustrating an insulating film used in the method of manufacturing the lead member according to another embodiment of the present disclosure.

FIG. 14 is a drawing schematically illustrating one step in the method of manufacturing the lead member according to another embodiment of the present disclosure.

### EMBODIMENT FOR CARRYING OUT THE INVENTION

### Problems to be Solved by this Disclosure

There may be a gap between a conductor and an insulating film in a lead member for a secondary battery. To address such a problem, Patent Document 2 proposes a conductor that is processed to have a taper from the upper surface and the lower surface of the conductor to the side surfaces.

However, according to the inventors of the present application, it is often found that the above-described “gap” is still present even when the solution described in Patent Document 2 is adopted.

The present disclosure is made in view of such a background, and it is an object of the present disclosure to provide a lead member that significantly suppresses generation of the gap between the side surface of the conductor and an insulating film. Additionally, it is an object of the present disclosure to provide a package of a secondary battery including such a lead member, and a method of manufacturing such a lead member.

### Effect of the Present Disclosure

In the present disclosure, a lead member that significantly suppresses generation of the gap between the side surface of the conductor and the insulating film can be provided. Additionally, in the present disclosure, a package of a secondary battery including such a lead member and a method of manufacturing such a lead member may be provided.

### Description of Embodiments of the Present Disclosure

In the following, one embodiment of the present disclosure will be described with reference to the drawings.

(Lead Member for Conventional Secondary Battery)

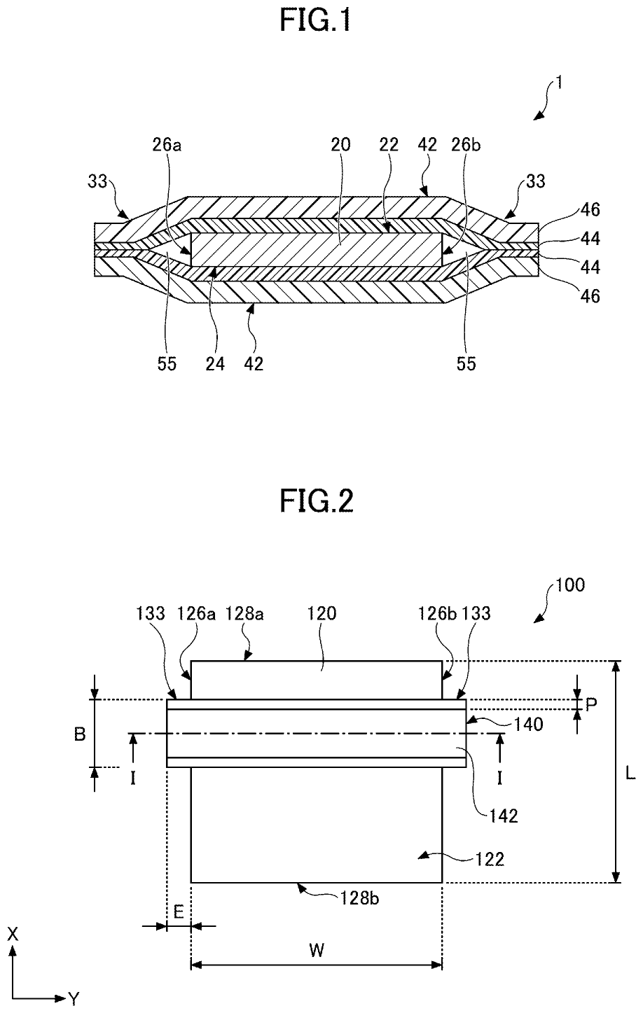

First, to better understand the features according to one embodiment of the present disclosure, a configuration of a lead member for a conventional secondary battery will be briefly described with reference to FIG. 1.

FIG. 1 schematically illustrates a cross-section of the lead member for the conventional secondary battery. As illustrated in FIG. 1, a lead member 1 for the conventional secondary battery includes a conductor 20 and insulating films 42.

The insulating films 42 are placed over and under the conductor 20. Additionally, a portion of the conductor 20 is enclosed between the upper insulating film 42 and the lower insulating film 42 by sticking the upper insulating film 42 and the lower insulating film 42 to each other.

Although not clearly illustrated in FIG. 1, the conductor 20 has a plate shape. That is, the conductor 20 has an upper surface 22 and a lower surface 24 that are rectangular and opposite to each other, a first side surface 26a and a second side surface 26b that are opposite to each other, and a first end surface and a second end surface that are opposite to each other. Here, in FIG. 1, the first end and second end surfaces of the conductor 20 cannot be recognized.

The first side surface 26a and the second side surface 26b, as well as the first end surface and the second end surface are surfaces connecting the upper surface 22 to the lower surface 24.

FIG. 1 illustrates a cross-section of lead member 1 in a direction parallel to the first end surface and the second end surface of the conductor 20. In FIG. 1, the left and right sides of the conductor 20 correspond to the first side surface 26a and the second side surface 26b, respectively.

The upper and lower insulating films 42 each are formed of two layers and have an inner layer 44 and an outer layer 46. The inner layer 44 of the insulating film 42 is formed of a resin material. The outer layer 46 of the insulating film 42 is formed of a resin material having a higher melting point than that of the inner layer 44 and having heat resistance.

When manufacturing such a lead member 1, first, the rectangular insulating films 42 are aligned with each other and placed at predetermined positions on the upper surface 22 side and the lower surface 24 side of the conductor 20.

In FIG. 1, when the right and left direction is referred to as the width direction, the size of each insulating film 42 in the width direction is selected to be longer than the size of the conductor 20 in the width direction. Thus, when the insulating films 42 are placed over and under the conductor 20, each insulating film 42 protrudes from the first side surface 26a and the second side surface 26b of the conductor 20.

Next, in this state, a hot press process is performed on the insulating films 42. That is, the insulating films 42 are pressed from the upper and lower sides (or from the upper side) with heat being applied to the insulating films 42.

The hot press process is pertained at a temperature at which the inner layer 44 of the insulating film 42 melts but the outer layer 46 does not melt. Thus, during performing the hot press process, only the inner layer 44 of each insulating film 42 melts. Thus, the protruding ends of the inner layers 44 of the respective insulating films 42 are welded together with the conductor 20 being enclosed therebetween.

As a result, as illustrated in FIG. 1, protrusions 33 of the insulating films 42 are respectively formed on the first side surface 26a side and the second side surface 26b side of the conductor 20. This forms the lead member 1.

Here, in the method of manufacturing the conventional lead member 1, there may be a case in which the inner layers 44 do not expand sufficiently during performing the hot press process, and the inner layers 44 of the insulating films 42 do not properly contact the desired locations closely on the first side surface 26a and the second side surface 26b of the conductor 20. In this case, as illustrated in FIG. 1, gaps 55 are generated between the first side surface 26a of the conductor 20 and the inner layer 44 and between the second side surface 26b of the conductor 20 and the inner layer 44 in the lead member 1.

When the lead member 1 is applied to a package accommodating a secondary battery, such gaps 55 may cause leakage of the electrolyte from the secondary battery side, leakage of the reaction product generated in the outer package, or the like. Therefore, it is necessary to suppress such gaps 55 as much as possible.

Especially in recent years, with the increase in the capacity and output of the secondary battery, the increase in the temperature of each member used for the package of the secondary battery is considered as a problem. Additionally, as part of a solution to this, it is examined that the conductor 20 used in the lead member 1 is thickened so as to facilitate heat radiation from the secondary battery.

However, in the conventional lead member 1, when the conductor 20 is thickened, the problem of the gap 55 described above is expected to become more pronounced.

In order to suppress the above-described gap 55 in the conventional lead member 1, it is conceivable that pressing pressure to the insulating sheet 40 from the upper and lower sides is increased or the temperature of the hot press process is increased so that the inner layer 44 sufficiently expands to the first and second side surfaces 26a and 26b of the conductor 20 during performing the hot press process.

However, such a process may lead to a longer manufacturing process of the lead member 1 and may cause a decrease in the production efficiency. Additionally, in this case, after the production of the lead member 1, a problem that the inner layer 44 significantly spreads from the outer layer 46 in a direction from the first end surface to the second end surface of the conductor 20 or vice versa may occur.

Additionally, as an alternative solution, it is conceivable that the first side surface 26a and the second side surface 26b of the conductor 20 are processed to have a taper. However, according to the inventors of the present application, it is often found that even with such processing to have a taper, the gap 55 is still present in the manufactured lead member 1. Further, when the conductor 20 is thicker, the solution of the taper may obtain insufficient effect.

With respect to the above, in one embodiment of the present disclosure, a lead member for a secondary battery, including a conductor and a covering material, is provided. The conductor has an upper surface and a lower surface that extend in a length direction and a width direction and that are opposite to each other, and a first side surface and a second side surface that extend in the length direction and a thickness direction, connect the upper surface to the lower surface, and are opposite to each other. The covering material is famed by sticking a plurality of insulating films together to surround the upper surface, the first side surface, the lower surface, and the second side surface. Each of the plurality of insulating films includes an inner layer and an outer layer, in an order from a side closer to the conductor. The lead member includes a first insulator and a second insulator on the first side surface and the second side surface of the conductor respectively, in an area surrounded by the covering material of the conductor. The first insulator and the second insulator have a lower melting point than the inner layer. The first insulator and the second insulator are placed to be separated from each other.

Here, in the present application, a term “placed to be separated from each other” with respect to the first and second insulators indicates that the first insulator and the second insulator are not in contact with each other on either the upper surface or the lower surface of the conductor.

Additionally, in one embodiment of the present disclosure, a method of manufacturing a lead member for a secondary battery is provided. The method includes:

a) a step of preparing a conductor having a first surface and a second surface that are opposite to each other, and a third surface and a fourth surface that are opposite to each other and are orthogonal to the first surface and the second surface;

b) a step of placing insulator materials on a portion of the first surface and a portion of the second surface, the insulator material having an insulating property;

c) a step of placing a first insulating film including a first inner layer and a first outer layer s to cover the insulator materials when viewed from the third surface such that the first inner layer faces the third surface;

d) a step of placing a second insulating film including a second inner layer and a second outer layer to cover the insulator materials when viewed from the fourth surface such that the second inner layer faces the fourth surface; and

e) a step of welding the first insulating film and the second insulating film to each other on a first surface side and on a second surface side.

Additionally, in one embodiment of the present disclosure, a method of manufacturing a lead member for a secondary battery is provided. The method includes:

a) a step of preparing a first insulating film including a first inner layer and a first outer layer, and a second insulating film including a second inner layer and a second outer layer;

b) a step of placing first insulator materials on portions of the first inner layer in the first insulating film;

c) a step of preparing a conductor having a first surface and a second surface that are opposite to each other, and a third surface and a fourth surface that are opposite to each other and are orthogonal to the first surface and the second surface;

d) a step of placing the first insulating film such that the first inner layer faces the third surface of the conductor when viewed from the third surface, the first insulator materials being placed on a portion of the first surface of the conductor and a portion of the second surface of the conductor;

e) a step of placing the second insulating film such that the second inner layer faces the fourth surface of the conductor when viewed from the fourth surface; and

f) a step of welding the first insulating film and the second insulating film to each other on a first surface side and on a second surface side.

In one embodiment of the disclosure, the first and second insulators are placed on the first and second side surfaces, respectively, in an area surrounded by the covering material of the conductor. Such a lead member configuration significantly reduces the possibility of generation of the above-described gap 55 on the first and second side surfaces of the conductor.

Therefore, in one embodiment of the present disclosure, the problem of the gap 55 that may occur in the conventional lead member 1 can be significantly reduced or eliminated.

(Lead Member for the Secondary Battery According to One Embodiment of the Disclosure)

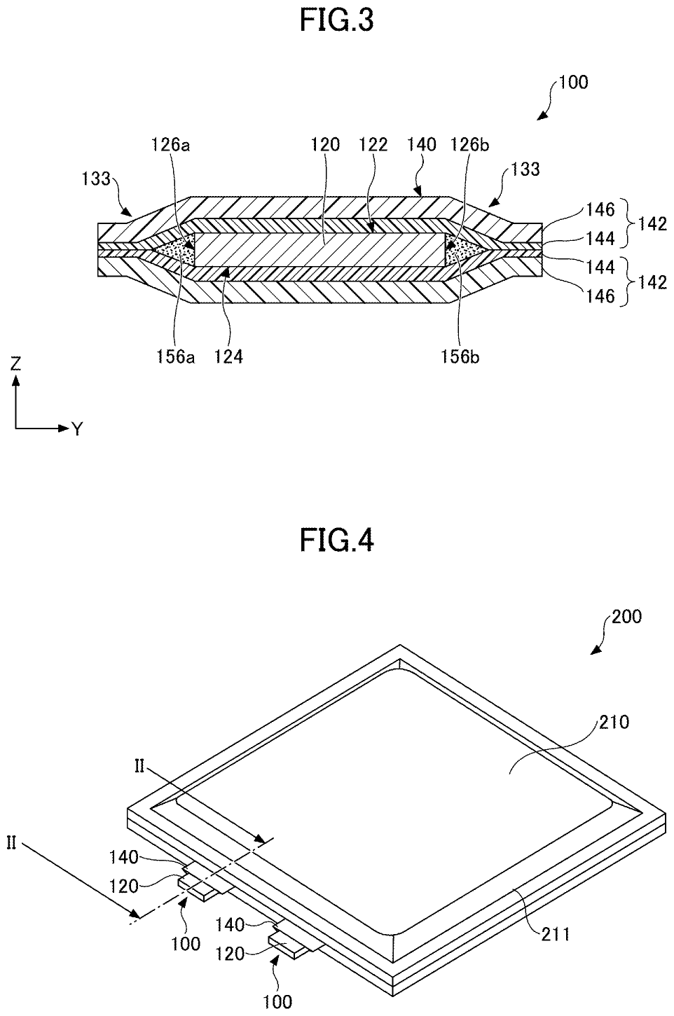

Next, a specific configuration example of a lead member for a secondary battery according to one embodiment of the present disclosure will be described with reference to FIG. 2 and FIG. 3.

FIG. 2 illustrates a schematic top view of the lead member for the secondary battery according to one embodiment of the present disclosure. FIG. 3 schematically illustrates a cross-section along the I-I line of the lead member for the secondary battery according to one embodiment of the present disclosure illustrated in FIG. 2.

As illustrated in FIG. 2 and FIG. 3, a lead member 100 for the secondary battery (hereinafter referred to as a “first lead member”) according to one embodiment of the present disclosure includes a conductor 120 and a covering material 140.

As illustrated in FIG. 2, the conductor 120 has a plate shape. The conductor 120 has an upper surface 122 and a lower surface 124 that are rectangular and opposite to each other, a first side surface 126a and a second side surface 126b that are opposite to each other, and a first end surface 128a and a second end surface 128b that are opposite to each other. The first side surface 126a and the second side surface 126b, and the first end surface 128a and the second end surface 128b are surfaces connecting the upper surface 122 to the lower surface 124.

Here, for the purpose of clarification of the description, in the present application, hereinafter, the X direction in FIG. 2 and FIG. 3 is referred to as the “length direction,” the Y direction is referred to as the “width direction,” and the Z direction is referred to as the “thickness direction”. Thus, for example, the “width direction” (the Y direction) of the conductor 120 is perpendicular to the “length direction” (the X direction) and the “thickness direction” (the Z direction).

Additionally, in the present application, the distance from the first end surface 128a to the second end surface 128b in the length direction of the conductor 120 is referred to as the “length L” of the conductor 120. The distance from the first side surface 126a to the second side surface 126b of the conductor 120 is referred to as the “width W” of the conductor 120. Furthermore, the distance from the upper surface 122 to the lower surface 124 of the conductor 120 is referred to as the “thickness t” of the conductor 120.

Here, when the distance from the first end surface 128a to the second end surface 128b in the conductor 120 is not constant, the “length L” of the conductor 120 represents the maximum size. The same applies to the “width W” and the “thickness t” of the conductor 120.

The covering material 140 is placed to surround the periphery of the conductor 120 in a portion in the length direction (in the X direction), except for the first end surface 128a and the second end surface 128b of the conductor 120. Here, in the present application, the area surrounded by the covering material 140 of the conductor 120 is also referred to as the “covered portion”.

In practice, the covering material 140 is formed by welding multiple insulating films together with the conductor 120 being interposed therebetween.

For example, in the example illustrated in FIG. 2 and FIG. 3, the covering material 140 is famed of two insulating films 142, each including an inner layer 144 and an outer layer 146.

That is, the covering material 140 is formed by placing two insulating films 142 on the upper surface 122 side and the lower surface 124 side of the conductor 120 such that the inner layers 144 are placed inward and welding the inner layers 144 of both of the insulating films 142 to each other.

In the example illustrated in FIG. 2 and FIG. 3, two insulating films 142 are joined on the first side surface 126a side and the second side surface 126b side of the conductor 120. Thus, protrusions 133 of the covering material 140 are formed on the first side surface 126a side and the second side surface 126b side of the conductor 120.

Here, as illustrated in FIG. 3, in the first lead member 100, a first additional layer 156a (also referred to as a “first insulator”) is placed on the first side surface 126a of the conductor 120. Additionally, a second additional layer 156b (also referred to as a “second insulator”) is placed on the second side surface 126b of the conductor 120.

Because of the presence of such a first additional layer 156a, in the first lead member 100, a gap is unlikely to exist between the first side surface 126a of the conductor 120 and the inner layers 144 of the upper and lower insulating film 142 that are close to the first side surface 126a. Similarly, because of the presence of the second additional layer 156b, a gap is unlikely to exist between the second side surface 126b of the conductor 120 and the inner layers 144 of the upper and lower insulating films 142 that are close to the second side surface 126b.

As a result, the first lead member 100 can significantly suppress the problem of the gap 55 in the conventional lead member 1.

(Each Component)

Next, each component used in the lead member according to one embodiment of the present disclosure will be described in more detail. Here, for the purpose of clarification, the first lead member 100 illustrated in FIG. 2 and FIG. 3 will be used as an example to describe the components. Accordingly, the reference sins illustrated in FIG. 2 and FIG. 3 are used to represent respective components.

(Conductor 120)

The conductor 120 may be formed of any material as long as a good electrical connection is formed between electrode of the secondary battery or leads of the secondary battery.

The conductor 120 may be formed of a metal, such as aluminum or copper, for example. Additionally, the conductor 120 may be formed by placing various coating films on a surface of a base material. Such coating films include, for example, metal plating films. In this case, the base material may be electrically conductive or have an insulating property.

The length of the conductor 120 (see the length L in FIG. 2) may be in the range of, although not limited to, 20 mm to 90 mm, for example. Additionally, the width of the conductor 120 (see the width W in FIG. 2) may be in the range of, although not limited to, 10 mm to 100 mm, for example. Further, the thickness t of the conductor 120 may be in the range of, although not limited to, 0.1 mm to 3 mm, for example.

Particularly, the first lead member 100 can significantly suppress generation of the gap 55 that may occur in the conventional lead member 1 even if the conductor 120 is thickened.

Additionally, at least either the first side surface 126a or the second side surface 126b of the conductor 120 may be tapered. In this case, generation of the gap can be further suppressed at the first side surface 126a and the second side surface 126b of the conductor 120.

(Covering Material 140)

The covering material 140 is formed of multiple insulating films 142 as described above. In the example illustrated in FIG. 2 and FIG. 3, the covering material 140 is formed by sticking two upper and lower insulating films 142 together at the first side surface 126a and the second side surface 126b of the conductor 120.

However, this is only one example, and the joints of the two insulating films 142 are not particularly limited. Additionally, the covering material 140 may be formed of three or more insulating films 142. In the covering material 140, the length of the protrusion 133 in the width direction, i.e., the size of the protrusion from the first side surface 126a or the second side surface 126b of the conductor 120 (see the size E illustrated in FIG. 2), is not particularly limited, but is, for example, in the range of 2 mm to 25 mm. Additionally, the size of the covering material 140 in the length direction, i.e., the size B illustrated in FIG. 2, is not particularly limited, but is, for example, in the range of 5 mm to 20 mm.

(Insulating Film 142)

The insulating film 142 has a multi-layer structure and includes at least two layers of the inner layer 144 and the outer layer 146. However, the insulating film 142 may include three or more layers.

The thickness of the insulating film 142 may be appropriately selected. Particularly, it is preferable that the thickness of the insulating film 142 is 20 μm or greater because a failure such as breakage caused by excessive thickness is unlikely to occur. However, if the insulating film 142 is too thick, this causes the first lead member 100 to become thicker. Therefore, the thickness of the insulating film 142 is preferably 20 μm or greater and 100 μm or less, and more preferably 30 μm or greater and 60 μm or less.

The inner layer 144 of insulating film 142 is typically formed of an insulating resin.

The inner layer 144 may contain, for example, 40 wt % or greater of polyolefin resin.

Examples of the polyolefin resin include polyethylene, polypropylene, ionomer resins, modified polyolefins, and the like. Particularly, adhesive polyolefin resins are preferable, from the viewpoint of the adhesion to the conductor 120.

The adhesive polyolefin resins refer to polyolefin resins that are modified with carboxylic acid, such as maleic acid, acrylic acid, methacrylic acid and maleic anhydride, epoxy, or the like to have an adhesive functional group. Particularly, maleic anhydride-modified polyolefin resins are preferable because of its excellent adhesion to the conductor 120 and a sealing property.

The resin component contains an acid-containing polyolefin resin obtained by incorporating an acid-containing group into the polyolefin resin.

The polyolefin resin is a synthetic resin made by polymerizing or copolymerizing olefin-based monomers having radical polymerizable unsaturated double bonds. The olefinic monomers are not particularly limited, but examples of the olefinic monomers include alpha-olefins such as ethylene, propylene, 1-butene, 1-pentene, 1-hexene, 1-heptene, 1-octene, 4-methyl-1-pentene, conjugated dienes such as butadiene, isoprene, and the like. The olefinic monomers may be used singly or in combination of two or more species.

Examples of the polyolefin resin include polyethylene, such as low density polyethylene, medium density polyethylene, high density polyethylene, linear low density polyethylene; polypropylene, such as homo polypropylene, a block copolymer of polypropylene, a random copolymer of polypropylene; terpolymers of ethylene-butene-propylene, and the like. Among these polyolefins, polyethylene and polypropylene are preferable.

Particularly, the inner layer 144 preferably contains 40 wt % or greater of an acid-modified polypropylene component, such as maleic anhydride-modified polypropylene.

The outer layer 146 of the insulating film 142 is also typically formed of an insulating resin. However, the outer layer 146 has a higher melting point than the inner layer 144 and is formed of a resin having heat resistance when a process of sticking the insulating films together is performed.

The outer layer 146 may include, for example, polyethylene terephthalate (PET) or may be formed of PET.

The thickness of the inner layer 144 normally changes in accordance with locations. While the inner layer 144 is relatively thick on sides facing the upper surface 122 and the lower surface 124 of the conductor 120 (hereinafter referred to as the “upper and lower sides”), the inner layer 144 tends to be relatively thin on sides facing the first side surface 126a and the second side surface 126b of the conductor 120 (hereinafter referred to as the “lateral sides”).

The thickness of the inner layer 144 on the upper and lower sides may be in the range of, for example, 1 μm to 10 μm, and preferably in the range of 2 μm to 5 μm. Also, the thickness of the inner layer 144 may be thinner on the lateral sides than the thickness on the upper and lower sides.

With respect to the above, the outer layer 146 tends to change less in thickness in accordance with locations than the inner layer 144. The thickness of the outer layer 146 is in the range of, for example, 30 mm to 60 mm, on the upper and lower sides and the lateral sides.

The inner layer 144 has a higher melting point than the first additional layer 156a and the second additional layer 156b. The inner layer 144 preferably has a melting point in the range of 135° C. to 160° C., and more preferably has a melting point in the range of 140° C. to 160° C.

The melting point of the inner layer 144 is equal to or greater than 135° C., so that the resin component of the inner layer 144 flows, during heating for the formation of the covering material 140, thereby sufficiently increasing the adhesion between the conductor 120 and the insulating film 142. When the melting point of the inner layer 144 is 160° C. or greater, it is necessary to apply a corresponding amount of heat to obtain fluidity. Therefore, it is desirable that the melting point of the inner layer 144 is 160° C. or less.

Here, the melting point of the inner layer 144 is measured by a differential scanning calorimetry (DSC).

In general, in the first lead member 100, with respect to the size of the insulating film 142 in the length direction (the X direction), the size of the inner layer 144 tends to be longer in than the size of the outer layer 146.

This is because the inner layer 144 melts during sticking together of the insulating films 142 in the hot press process and tends to stretch in the length direction (the X direction).

Due to such a difference in the properties of the inner layer 144 and the outer layer 146, what is called a “spread” phenomenon, in which the inner layer 144 protrudes from the outer layer 146 along the length direction (the X direction) in the covering material 140 of the manufactured first lead member 100, may occur.

Particularly, in the conventional lead member 1, in order to reduce the risk of generation of the gap 55, the pressing pressure to the insulating film 42 from the upper and lower sides may be increased more than necessary, or the temperature of the hot press process may be increased more than necessary, during the hot press process in the manufacturing process.

However, when such a processing condition is employed, in the obtained lead member 1, the “spread” of the inner layer 44 with respect to the outer layer 46 becomes more pronounced. Additionally, when such a high temperature and high pressure condition is employed, a longer time is required to manufacture the lead member 1, which may cause a decrease in the production efficiency.

With respect to the above, in the first lead member 100, the first additional layer 156a and the second additional layer 156b are respectively placed on the first side surface 126a and the second side surface 126b of the conductor 120. Thus, the conventional gap 55 is unlikely occur at the first side surface 126a and the second side surface 126b of the conductor 120.

Thus, in the case of the first lead member 100, it is not necessary to press or heat the inner layer 144 more than necessary during the formation of the covering material 140, and thus the insulating films 142 can be joined at lower pressing pressure and/or a lower temperature.

Therefore, in the first lead member 100, the “spread” of the inner layer 144 in the length direction (the X direction) can be significantly suppressed in comparison with the conventional lead member 1.

For example, the spread amount P of the inner layer 144 represented by “P” in FIG. 2 can be 2 mm or less.

Additionally, in this case, when the insulating films 142 are joined, an extreme high temperature and high pressure condition is not required, and the time for manufacturing the first lead member 100 is shortened, so that the first lead member 100 can be manufactured more efficiently.

In the first lead member 100, the size of the inner layer 144 of the insulating film 142 in the length direction (the X direction) is in the range of, for example, 5 mm to 20 mm. With respect to this, the size of the outer layer 146 of insulating film 142 in the length direction (X direction) is in the range of, for example, 5 mm to 22 mm.

(First Additional Layer 156a and Second Additional Layer 156b)

The first additional layer 156a is famed of a material having a lower melting point than that of the inner layer 144. This allows the first additional layer 156a to be more fluidized than the inner layer 144 when sticking two insulating films 142 together. As a result, the first additional layer 156a can be more uniformly and rapidly distributed on the first side surface 126a of the conductor 120.

For example, the first additional layer 156a has a melting point in the range of 110° C. to 140° C. and preferably has a melting point in the range of 120° C. to 135° C.

The melting point of the first additional layer 156a is measured by a differential scanning calorimetry (DSC).

The first additional layer 156a may be formed of, for example, an insulating resin. Examples of the resin included in the first additional layer 156a include, although not limited to, a polyolefin resin.

Examples of the polyolefin resin include polyolefins, cyclic polyolefins, acid modified polyolefins, and acid modified cyclic polyolefins. That is, the resin forming the first additional layer 156a may or may not contain a polyolefin backbone, and preferably contain a polyolefin backbone.

It can be found whether the resin forming the first additional layer 156a contains the polyolefin backbone, by infrared spectroscopy, gas chromatography mass spectrometry, or the like, for example.

For example, when maleic anhydride-modified polyolefins are measured by infrared spectroscopy, peaks derived from maleic anhydride are detected at wave numbers in vicinity of 1760 cm⁻¹ and 1780 cm⁻¹. However, peaks may not be detected if the degree of acid modification is low. In this case, the presence or absence of the polyolefin backbone is analyzed by nuclear magnetic resonance spectroscopy.

Specific Examples of such polyolefins include polyethylene, such as low density polyethylene, medium density polyethylene, high density polyethylene, linear low density polyethylene; polypropylene, such as homo polypropylene, a block copolymer of polypropylene (e.g., a block copolymer of propylene and ethylene), a random copolymer of polypropylene (e.g., a random copolymer of propylene and ethylene); a terpolymer of ethylene-butene-propylene, and the like. Among these polyolefins, polyethylene and polypropylene are preferable.

The cyclic polyolefin is a copolymer of an olefin and a cyclic monomer. Examples of the olefin being a constituent monomer of the cyclic polyolefin include ethylene, propylene, 4-methyl-1-pentene, butadiene, isoprene, and the like. Examples of the cyclic monomer being a constituent monomer of the cyclic polyolefin include cyclic alkenes such as norbornene; specifically, cyclic dienes, such as cyclopentadiene, dicyclopentadiene, cyclohexadiene, norbornadiene and the like. Among these polyolefins, cyclic alkenes are preferable and norbornenes are more preferable. The acid-modified polyolefin is a polymer modified by performing block or graft polymerization on the polyolefin with an acid component such as a carboxylic acid. Examples of the acid component used for the modification include carboxylic acids such as maleic acid, acrylic acid, itaconic acid, crotonic acid, maleic anhydride, itaconic anhydride, and the like, or anhydrides thereof.

The acid-modified cyclic polyolefin is a polymer obtained by performing copolymerization by replacing a portion of the monomers constituting the cyclic polyolefin with an α,β-unsaturated carboxylic acid or its anhydride, or by performing block or graft polymerization on the cyclic polyolefin with an α,β-unsaturated carboxylic acid or its anhydride. The carboxylic acid modified cyclic polyolefin is substantially the same, as described above. The carboxylic acid used for the modification is substantially the same as that used for the modification of the acid-modified polyolefin.

Among these resin components, polyolefins such as polypropylene and carboxylic acid modified polyolefins are preferable, and polypropylene and acid modified polypropylene are more preferable.

The first additional layer 156a may contain, for example, 40 wt % or greater of a polyolefin resin, such as an acid modified polyolefin.

Other materials contained in the first additional layer 156a are not particularly limited. The first additional layer 156a may contain, for example, a thermoplastic resin having a lower melting point than that of a polypropylene resin, such as a low density polyethylene, an ethylene-vinyl acetate copolymer, an ethylene-acrylate ester copolymer, or the like, a copolymer of polybutene and ethylene and/or butene and alpha-olefin; a low melting point polypropylene, such as a block copolymer, a random copolymer, a graft copolymer, or the like known as a copolymer of propylene and alpha-olefin; a resin such as a low melting point polyester in which at least one portion of a terephthalic acid unit is substituted with a dicarboxylic acid, such as isophthalic acid, adipic acid, phthalic acid, or the like in polyethylene terephthalate or polybutylene terephthalate, a synthetic rubber, such as ethylene-propylene rubber, ethylene-propylene-diene rubber, styrene-butadiene rubber, polybutadiene rubber, chlorinated polyethylene, polyisobutylene, or mixtures thereof; or thermosetting adhesives such as isocyanate-based adhesives or the like.

The second additional layer 156b is substantially the same as the first additional layer 156a.

Here, the first additional layer 156a and the second additional layer 156b are not necessarily formed of the same material. However, from the viewpoint of process simplification, it is preferable that the first additional layer 156a and the second additional layer 156b are formed of the same material.

(Application Example of the Lead Member According to One Embodiment of the Disclosure)

Next, an application example of the lead member according to one embodiment of the present disclosure will be described. Here, as the application example of the lead member according to one embodiment of the present disclosure, a package of a secondary battery is used, and a configuration thereof will be described. Additionally, the configuration of the package of the secondary battery will be described herein by using the first lead member 100 as an example of the lead member according to one embodiment of the present disclosure.

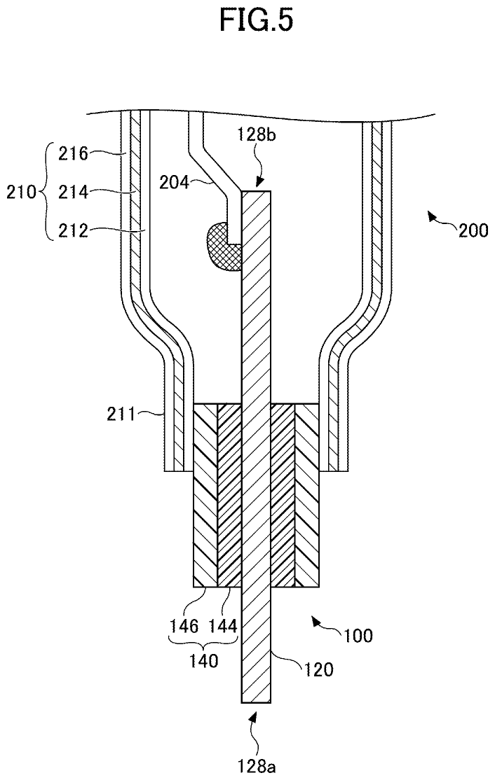

FIG. 4 and FIG. 5 schematically illustrate a configuration example of the package of the secondary battery including the lead member according to one embodiment of the present disclosure. FIG. 4 is a schematic perspective view of the package of the secondary battery including the lead member according to one embodiment of the present disclosure. FIG. 5 is a cross-sectional view of the package illustrated in FIG. 4 along the line II-II.

As illustrated in FIG. 4 and FIG. 5, a secondary battery package 200 includes a secondary battery (not illustrated), such as a lithium-ion secondary battery, an enclosing casing 210 accommodating the secondary battery, and two first lead members 100.

The enclosing casing 210 serves to hermetically accommodate the secondary battery inside. Each lead member 100 is electrically connected to one of the electrodes of the secondary battery and serves to lead the two electrode terminals to the outside.

As illustrated in FIG. 5, the first lead member 100 is electrically connected, near a second end surface 128b, to a lead 204 extending from the secondary battery side. Although not apparent from FIG. 5, the lead 204 is electrically connected to one electrode of the secondary battery. Thus, the conductor 120 of each first lead member 100 can be utilized as an electrical connection terminal to a corresponding electrode of the secondary battery.

As illustrated in FIG. 5, the enclosing casing 210 includes at least three layers: an innermost layer 212, an intermediate layer 214, and an outermost layer 216. Among these, the innermost layer 212 is formed of a material that is resistant to the electrolyte of the secondary battery, such as a polyolefin resin. Additionally, the intermediate layer 214 is formed of metal such as, aluminum, copper, and stainless steel. Further, the outermost layer 216 is formed of a resin, such as, polyethylene terephthalate (PET), to protect the intermediate layer 214.

The enclosing casing 210 is foamed by, for example, performing heat fusion on two multilayered films arranged to cover the secondary battery from above and below along the outer periphery. This forms a seal region 211 along the periphery of the enclosing casing 210, as illustrated in FIG. 4.

Additionally, the second end surface 128b side of the first lead member 100 is inserted in advance between the multilayer films before the heat fusion is performed on the two multilayer films, so that the first lead member 100 is joined with the respective multilayer films during the heat fusion of the multilayer films. In this case, the first lead member 100 is placed with respect to the two multilayered films such that the first lead member 100 is bonded to the multilayer films at the position of the covering material 140.

Thus, as illustrated in FIG. 5, each of the first lead members 100 can be placed with respect to the enclosing casing 210 such that the first end surface 128a is led out of the enclosing casing 210 and the second end surface 128b is introduced into the enclosing casing 210. Additionally, the enclosing casing 210 can be bonded at the position of the covering material 140 of the first lead member 100.

In such a secondary battery package 200, the first lead member 100 is applied as the lead member. Thus, in the secondary battery package 200, the possibility of leakage of the electrolyte of the secondary battery from the side of the conductor of the lead member or leakage of reaction products generated inside the enclosing casing 210 through the gap in the lead member can be significantly suppressed.

(Method of Manufacturing the Lead Member According to One Embodiment of the Disclosure)

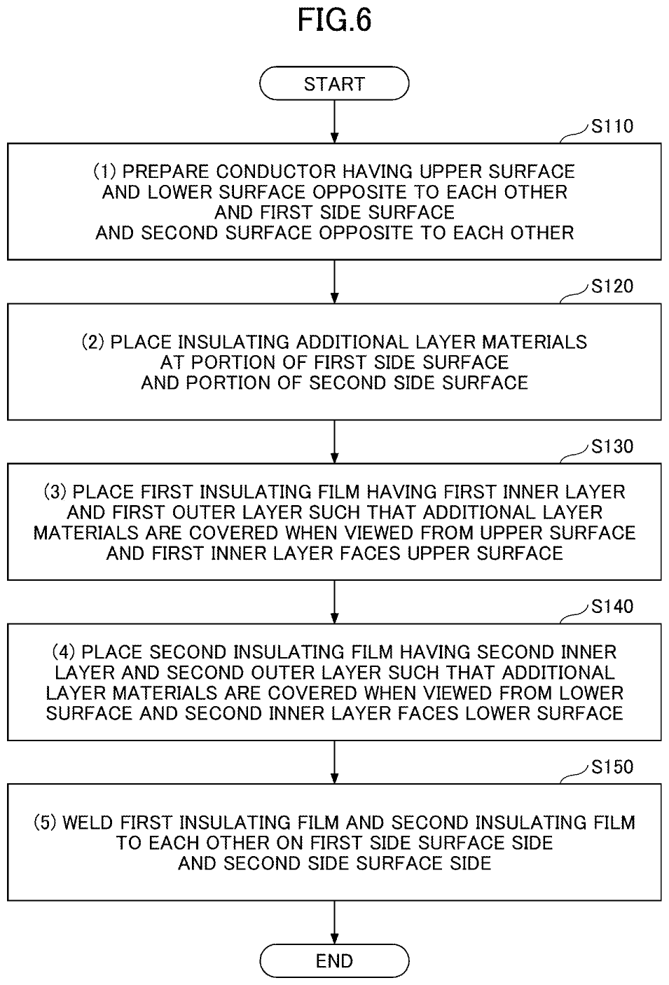

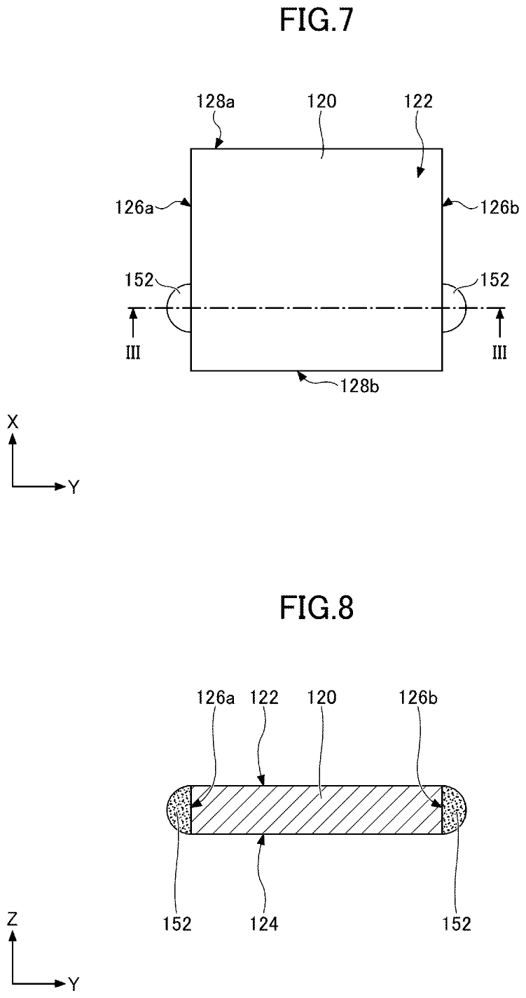

Next, an example of a method of manufacturing the lead member according to one embodiment of the present disclosure will be described with reference to FIGS. 6 to 11. FIG. 6 schematically illustrates a flow of the method of manufacturing the lead member) according to one embodiment of the present disclosure (hereinafter, referred to as a “first manufacturing method”. Additionally, FIGS. 7 to 11 each schematically illustrate one step of the first manufacturing method.

As illustrated in FIG. 6, the first manufacturing method includes:

(1) a step of preparing a conductor having an upper surface and a lower surface that are opposite to each other and a first side surface and a second side surface that are opposite to each other (step S110);

(2) a step of placing additional layer materials having an insulating property on a portion of the first side surface and a portion of the second side surface (step S120);

(3) a step of placing a first insulating film including a first inner layer and a first outer layer such that the additional layer materials are covered when viewed from the upper surface and the first inner layer faces the upper surface (step S130);

(4) a step of placing a second insulating film including a second inner layer and a second outer layer such that the additional layer materials are covered when viewed from the lower surface and the second inner layer faces the lower surface (step S140); and

(5) a step of welding the first insulating film and the second insulating film to each other on the first side surface side and on the second side surface side (step S150).

Each step will be described below. For the purpose of clarification, the first manufacturing method will be described by using the first lead member 100 illustrated in FIG. 2 and FIG. 3 as an example of the lead member. Accordingly, the reference signs illustrated in FIG. 2 and FIG. 3 are used to represent respective members.

(Step S110)

First, the conductor 120 is prepared. The conductor 120 has a plate form. As described above, the conductor 120 has the upper surface 122, the lower surface 124, the first side surface 126a, the second side surface 126b, the first end surface 128a, and the second end surface 128b.

The thickness of the conductor 120 is in the range of, for example, 0.1 mm to 3 mm, but is not particularly limited. Particularly, it should be noted that the first manufacturing method is also applicable to the relatively thick conductor 120.

The first side surface 126a and/or the second side surface 126b may be processed to have a taper. However, the tapering process is not required for the first manufacturing method.

(Step S120)

Next, additional layer materials (also referred to as “insulator materials”), which will be the first additional layer 156a and the second additional layer 156b later, are prepared.

The additional layer materials include an insulating resin. The examples of the insulating resin include resins described in the above section (the first additional layer 156a and the second additional layer 156b). Particularly, the additional layer material preferably contains 40 wt % or greater of polyolefin.

Here, it is preferable that the additional layer material is formed of a resin having a melting point lower than that of the resin forming the inner layer of the insulating film, which will be described later. In this case, the additional layer material can be sufficiently fluidized during performing the hot press process in the subsequent process. As a result, the additional layer material can be more uniformly and rapidly distributed to the first side surface 126a and the second side surface 126b of the conductor 120.

Next, the additional layer material is placed on each of the first side surface 126a and second side surface 126b of the conductor 120 (hereinafter collectively referred to as “side surfaces 126a and 126b”).

FIG. 7 and FIG. 8 schematically illustrate a state in which an additional layer material 152 is placed on each of the first side surface 126a and the second side surface 126b of the conductor 120. Here, FIG. 7 is a top view of the conductor 120. FIG. 8 is a cross-sectional view along the III-III line of FIG. 7.

A method of placing the additional layer material 152 is not particularly limited. The additional layer materials 152 may be placed on the side surfaces 126a and 126b of the conductor 120, for example, by a method of applying paste with a brush or the like, a method of spraying a liquid or a dispersion liquid containing a liquid and a solid, a method of printing ink with ink jet printing, or the like. In these methods, the additional layer material 152 can be placed relatively easily.

(Step S130 to step S140)

Next, a first insulating film 142a and a second insulating film 142b are prepared. The first insulating film 142a and the second insulating film 142b each include the inner layer 144 and the outer layer 146.

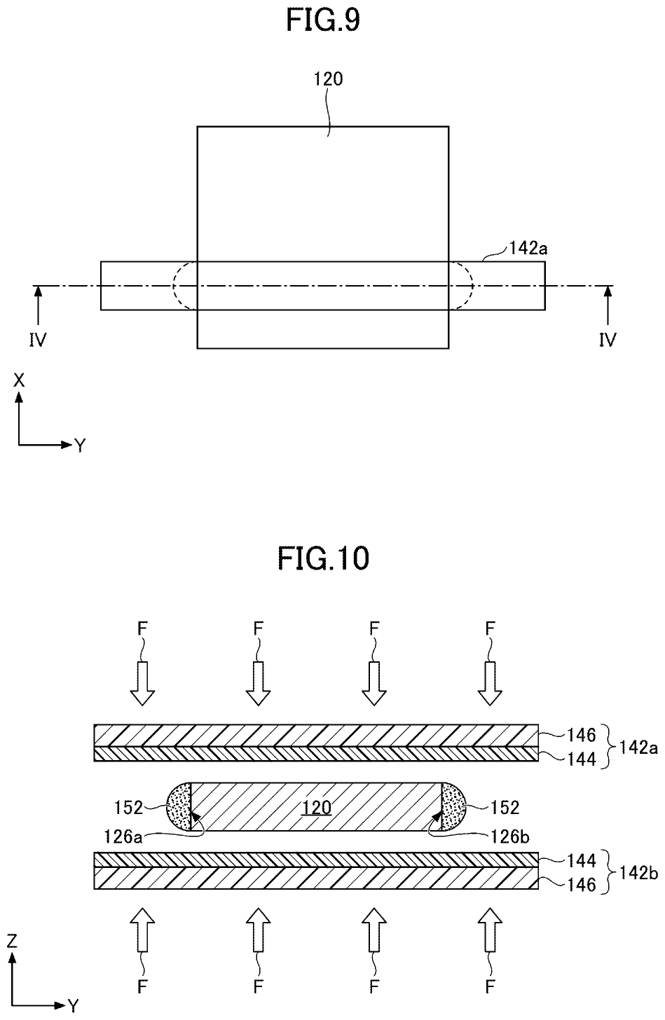

Additionally, as illustrated in FIG. 9 and FIG. 10, the first insulating film 142a is placed on the upper side of the conductor 120 to be opposite to the upper surface 122 of the conductor 120, and the second insulating film 142b is placed on the lower side of the conductor 120 to be opposite to the lower surface 124 of the conductor 120. The first insulating film 142a and the second insulating film 142b are placed such that the respective inner layers 144 are on the conductor 120 side.

Here, FIG. 9 is a schematic view of the conductor 120 sandwiched between the first insulating film 142a and the second insulating film 142b, viewed from the upper surface 122 side. Additionally, FIG. 10 is a virtual cross-sectional view of the assembly of FIG. 9 along the IV-IV line.

As illustrated in FIG. 9, the first insulating film 142a and the second insulating film 142b are arranged to include the portions of the side surfaces 126a and 126b where the additional layer materials 152 are placed when viewed from the upper surface 122 side of the conductor 120. Additionally, the first insulating film 142a and the second insulating film 142b are placed such that the first insulating film 142a and the second insulating film 142b overlap each other when viewed from the upper surface 122 side of the conductor 120.

(Step S150)

Next, the hot press process is performed on the first insulating film 142a and the second insulating film 142b in the directions indicated by the arrows F of FIG. 10.

The hot press process causes the first insulating film 142a to tightly contact the upper surface 122 of the conductor 120. Additionally, the second insulating film 142b is caused to tightly contact the lower surface 124 of the conductor 120.

Additionally, the inner layer 144 of the first insulating film 142a and the inner layer 144 of the second insulating film 142b are welded on sides of the side surfaces 126a and 126b of the conductors 120. As a result, the first insulating film 142a and the second insulating film 142b are joined to form the covering material 140 so as to surround a portion of the conductor 120.

Here, the additional layer materials 152 are placed on the side surfaces 126a and 126b of the conductor 120. These additional layer materials 152 are melted or are fluidized during performing the hot press process. Thus, after performing the hot press process, the first additional layer 156a can be formed between the first side surface 126a of the conductor 120 and the inner layers 144. The second additional layer 156b can also be formed between the second side surface 126b of the conductor 120 and the inner layers 144.

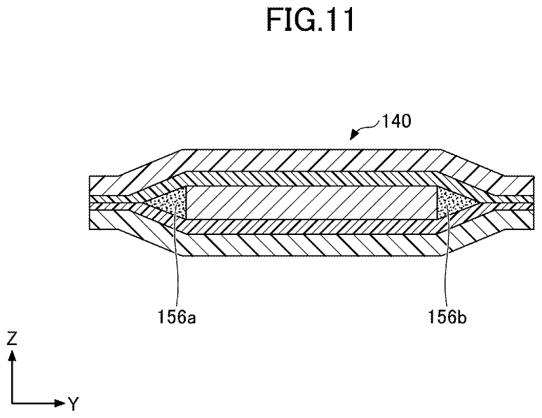

This produces the first lead member 100 having a cross-sectional configuration as illustrated in FIG. 11.

As illustrated in FIG. 11, the first lead member 100 manufactured by the first manufacturing method can significantly reduce the gaps between the side surfaces 126a and 126b of the conductor 120 and the inner layers 144 of the covering material 140, which may be generated in the conventional lead member 1.

Additionally, as described above, in the conventional lead member 1, in order to reduce the risk of generating the gap 55, pressing pressure to the insulating film 42 from the upper and lower sides may be increased more than necessary, or the temperature of the hot press process may be increased more than necessary during the hot press process in the manufacturing process.

However, when such a processing condition is employed, in the obtained lead member 1, the “spread” of the inner layer 44 with respect to the outer layer 46 becomes more pronounced. Additionally, when such a high temperature and high pressure condition is employed, a longer time is required to manufacture the lead member 1, which may cause a decrease in the production efficiency.

In contrast, in the first manufacturing method, in step S150, during the hot press process, there is no need to apply pressing pressure or heat to the inner layer 144 more than necessary, and the first and second insulating films 142a and 142b can be stuck together at lower pressing pressure and/or lower temperature. Thus, in the first manufacturing method, the first lead member 100, in which the “spread” of the inner layer 144 in the length direction (the X direction) is significantly suppressed in comparison with the conventional lead member 1, can be manufactured.

Additionally, in the first manufacturing method, when the first and second insulating films 142a and 142b are joined, the high temperature and high pressure conditions are not required, and thus the production time is shortened, so that the first lead member 100 can be manufactured more efficiently.

(Method of Manufacturing a Lead Member According to Another Embodiment of the Disclosure)

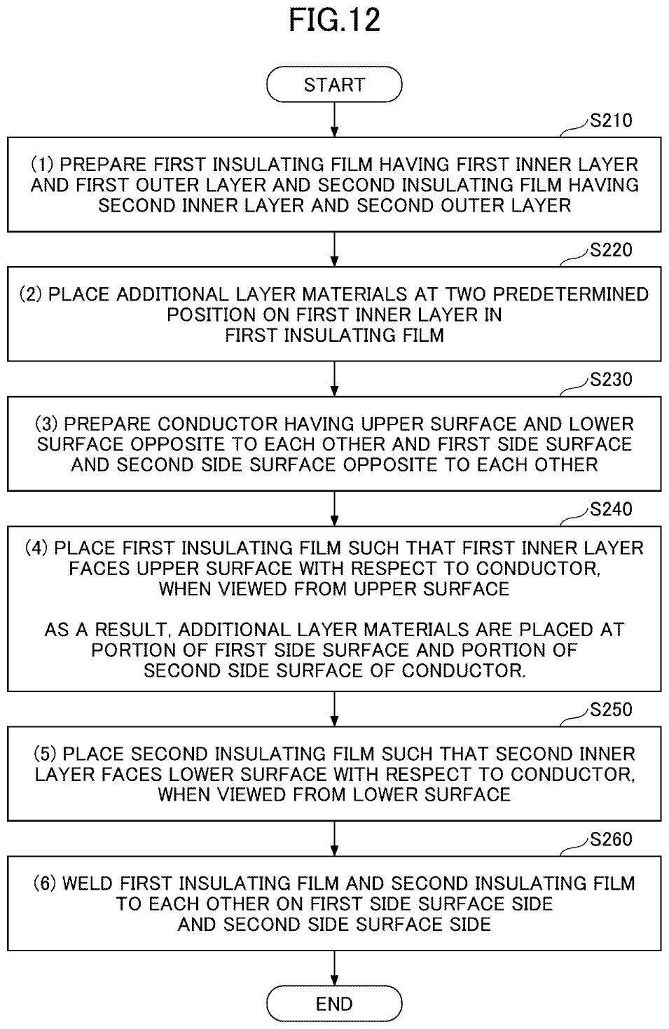

Next, a method of manufacturing a lead member according to another embodiment of the present disclosure will be described with reference to FIGS. 12 to 14.

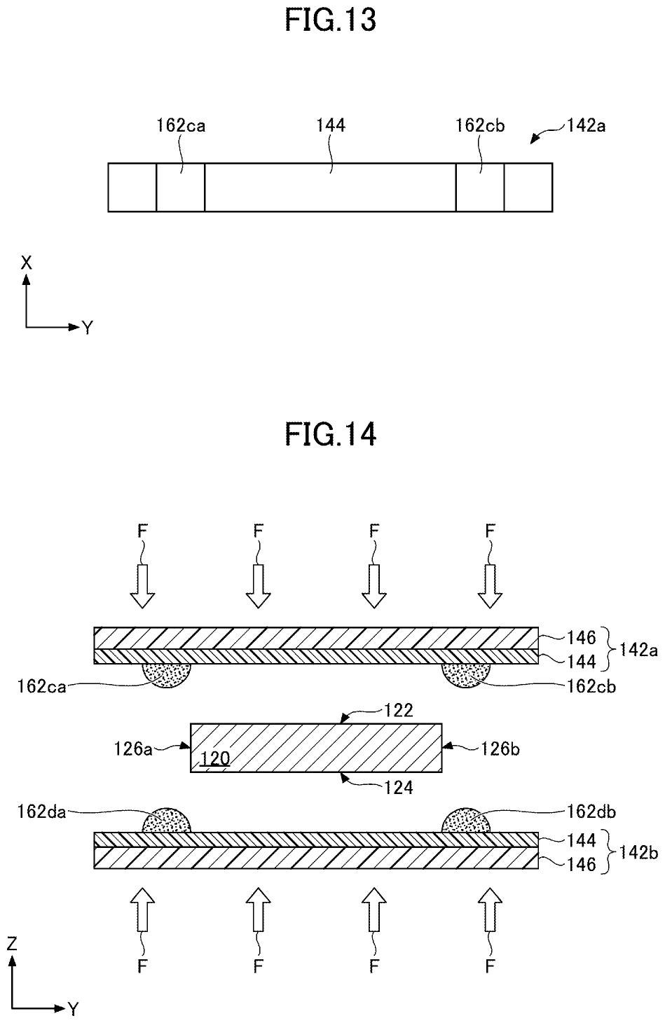

FIG. 12 schematically illustrates a flow of the method of manufacturing the lead member according to another embodiment of the present disclosure (hereinafter referred to as a “second manufacturing method”). Additionally, FIG. 13 and FIG. 14 each schematically illustrate one step of the second manufacturing method.

As illustrated in FIG. 12, the second manufacturing method includes:

(1) a step of preparing a first insulating film including a first inner layer and a first outer layer, and a second insulating film including a second inner layer and a second outer layer (step S210);

(2) a step of placing additional layer materials at two predetermined positions of the first inner layer in the first insulating film (step S220);

(3) a step of preparing a conductor having an upper surface and a lower surface that are opposite to each other and a first side surface and a second side surface that are opposite to each other (step S230);

(4) a step of placing the first insulating film such that the first inner layer faces the upper surface of the conductor when viewed from the upper surface, the additional layer materials being placed on a portion of the first side surface and a portion of the second side surface of the conductor (step S240);

(5) a step of placing the second insulating film such that the second inner layer faces the lower surface of the conductor when viewed from the lower surface (step S250); and

(6) a step of welding the first insulating film and the second insulating film to each other on the first side surface side and the second side surface side (step S260).

Each step will be described below. For the purpose of clarification, the second manufacturing method will be described by using the first lead member 100 illustrated in FIG. 2 and FIG. 3 as an example of the lead member. Accordingly, reference signs illustrated in FIG. 2 and FIG. 3 are used to represent respective members.

(Step S210)

First, the first insulating film 142a and the second insulating film 142b, which will later become the covering material 140, are prepared. The first insulating film 142a and the second insulating film 142b each include the inner layer 144 and the outer layer 146.

The first insulating film 142a and the second insulating film 142b may have the same configuration as the first insulating film 142a and the second insulating film 142b in the first manufacturing method described above, respectively.

(Step S220)

Next, the additional layer materials are placed at two positions on the inner layer 144 of the first insulating film 142a.

FIG. 13 illustrates a top view of the first insulating film 142a. FIG. 13 is a drawing of the first insulating film 142a viewed from the inner layer 144 side.

As illustrated in FIG. 13, the first insulating film 142a has additional portions formed in stripes and arranged perpendicular to an extending axial direction (the Y direction) of the first insulating film 142a at two positions along the extending axial direction. These additional portions formed in stripes are referred to as a first additional layer material 162ca and a second additional layer material 162cb in order from the left side of FIG. 13.

The first additional layer material 162ca and the second additional layer material 162cb are formed of a material substantially the same as that of the additional layer material 152 used for the side surfaces 126a and 126b of the conductor 120 in the above-described first manufacturing method.

Particularly, it is preferable that the first additional layer material 162ca and the second additional layer material 162cb are formed of a resin having a melting point lower than that of the inner layer 144. In this case, the first additional layer material 162ca and the second additional layer material 162cb can be sufficiently fluidized during performing the hot press process in subsequent steps.

Such a first additional layer material 162ca and a second additional layer material 162cb may be placed on the inner layer 144 of the first insulating film 142a by, for example, coating or ink jet printing.

The positions where the first additional layer material 162ca and the second additional layer material 162cb are placed in the first insulating film 142a are selected to correspond to the width and relative position of the conductor 120 used in the subsequent step S230. For example, when the width of the conductor 120 is W, the distance between the first additional layer material 162ca and the second additional layer material 162cb may be set in the range of W±1 mm.

Additionally, for example, in step S220, when the conductor 120 is placed substantially in the center of the first insulating film 142a in the width direction (the Y direction in FIG. 13), the first additional layer material 162ca and the second additional layer material 162cb may be placed approximately at an equal distance from the center of the first insulating film 142a in the width direction (the Y direction in FIG. 13).

Here, similarly in the second insulating film 142b, a third additional layer material 162da and a fourth additional layer material 162db may be placed at two positions on the inner layer 144 (see FIG. 14).

In this case, even when the first side surface 126a and the second side surface 126b of the conductor 120 are relatively thick, the additional layer materials can be securely placed on the first side surface 126a and the second side surface 126b in subsequent steps S240 to S250.

In the following, step S230 and later will be described by using the case where the third additional layer material 162da and the fourth additional layer material 162db are also placed on the inner layer 144 of the second insulating film 142b as an example.

(Step S230)

Next, the conductor 120 is prepared. The conductor 120 has a plate form. As described above, the conductor 120 has the upper surface 122, the lower surface 124, the first side surface 126a, the second side surface 126b, and the like.

(Step S240 to step S250)

Next, as illustrated in FIG. 14, the first insulating film 142a is placed on the upper side of the conductor 120 to be opposite to the upper surface 122 of the conductor 120, and the second insulating film 142b is placed on the lower side of the conductor 120 to be opposite to the lower surface 124 of the conductor 120.

The first insulating film 142a and the second insulating film 142b are placed such that the respective inner layers 144 are on the conductor 120 side. Additionally, as illustrated in FIG. 14, the first insulating film 142a is placed such that the first insulating film 142a and the second insulating film 142b overlap each other when viewed from the upper surface 122 side of the conductor 120.

Here, as described above, in the first insulating film 142a, the first additional layer material 162ca and the second additional layer material 162cb are placed at the predetermined positions on the inner layer 144. Additionally, in the second insulating film 142b, the third additional layer material 162da and the fourth additional layer material 162db are placed at the predetermined positions on the inner layer 144.

Thus, as illustrated in FIG. 14, when the first insulating film 142a and the second insulating film 142b are placed with respect to the conductor 120, both the first and third additional layer materials 162ca and 162da are placed such that the first and third additional layers 162ca and 162da are on or near the first side surface 126a of the conductor 120 when viewed from the upper surface 122 of the conductor 120. Similarly, both the second and fourth additional layer materials 162cb and 162db are placed such that the second and fourth additional layer materials 162cb and 162db are on or near the second side surface 126b of the conductor 120 when viewed from the lower surface 124 of the conductor 120.

(Step S260)

Next, the hot press process is performed on the first insulating film 142a and the second insulating film 142b in the directions indicated by the arrows F of FIG. 14. The hot press process causes the first insulating film 142a to tightly contact the upper surface 122 of the conductor 120. The second insulating film 142b is also caused to tightly contact the lower surface 124 of the conductor 120.

Additionally, the inner layer 144 of the first insulating film 142a and the inner layer 144 of the second insulating film 142b are welded on the sides of the side surfaces 126a and 126b of the conductor 120. As a result, the first insulating film 142a and the second insulating film 142b are joined to form the covering material 140 to surround a portion of the conductor 120.

At this time, the first and third additional layer materials 162ca and 162da in the molten or fluidized state are pressed from the upper side and the lower side against the first side surface 126a of the conductor 120. Similarly, the second and fourth additional layer materials 162cb and 162db in the molten or fluidized state are pressed from the upper side and the lower side against the second side surface 126b of the conductor 120.

As a result, after the hot press process is performed, the first additional layer 156a can be formed between the first side surface 126a of the conductor 120 and the inner layers 144. Additionally, the second additional layer 156b can be formed between the second side surface 126b of the conductor 120 and the inner layers 144.

This produces the first lead member 100 having a cross-sectional configuration as illustrated in FIG. 11 described above.

As illustrated in FIG. 11, the first lead member 100 manufactured in the second manufacturing method can significantly suppress the gaps between the side surfaces 126a and 126b of the conductor 120 and the inner layers 144 of the covering material 140, which may be generated in the conventional lead member 1.

Additionally, in the second manufacturing method, as in the first manufacturing method, the first lead member 100, in which the “spread” of the inner layer 144 in the length direction (the X direction) is significantly suppressed, can be manufactured in comparison with the conventional lead member 1.

Additionally, in the second manufacturing method, when the first and second insulating films 142a and 142b are joined, the high temperature and high pressure conditions are not required, and thus the production time is shortened, so that the first lead member 100 can be manufactured more efficiently.

As described above, the method of manufacturing the lead member according to one embodiment of the present disclosure has been described by using the first and second manufacturing methods as examples. However, these are merely examples, and the lead member according to one embodiment of the present disclosure may be manufactured by another method.

For example, in the second manufacturing method described above, in step S220, the additional layer materials 162ca and 162cb are placed at two positions of the first insulating film 142a, and the additional layer materials 162da and 162db are placed at two positions of the second insulating film 142b.

Alternatively, however, the additional layer materials 162da and 162db need not be placed on the second insulating film 142b side. Such an embodiment is beneficial, particularly when the conductor 120 is relatively thin.

Alternatively, only the first additional layer material 162ca (or the second additional layer material 162cb) may be placed on the first insulating film 142a side and only the fourth additional layer material 162db (or the third additional layer material 162da) may be placed on the second insulating film 142b side. Such an embodiment is also beneficial, particularly when the conductor 120 is relatively thin.

Various other modifications can be considered by a person skilled in the art. Accordingly, the scope of the present disclosure is defined by the description of the claims, and it is intended that the present disclosure include all modifications within the meaning and scope of the description and equivalents of the claims.

### DESCRIPTION OF THE REFERENCE NUMERALS

1 Conventional lead member
20 conductor
22 upper surface (third surface)
24 lower surface (fourth surface)
26a first side surface (first surface)
26b second side surface (second surface)
33 protrusion
42 insulating film
44 inner layer
46 outer layer
55 gap
100 first lead member
120 conductor
122 upper surface (third surface)
124 lower surface (fourth surface)
126a first side surface (first surface)
126b second side surface (second surface)
128a first end surface
128b second end surface
133 protrusion
140 covering material
142 insulating film
142a first insulating film
142b second insulating film
144 inner layer
146 outer layer
152 additional layer material (insulator material)
156a first additional layer (first insulator)
156b second additional layer (second insulator)
162ca first additional layer (insulator) material
162cb second additional layer (insulator) material
162da third additional layer (insulator) material
162db fourth additional layer (insulator) material
200 secondary battery package
204 lead wire
210 enclosing casing
211 seal region
212 innermost layer
214 intermediate layer
216 outermost layer

1. A lead member for a secondary battery, the lead member comprising:
a conductor; and
a covering material,
wherein the conductor has an upper surface and a lower surface that extend in a length direction and a width direction and are opposite to each other, and a first side surface and a second side surface that extend in the length direction and a thickness direction, connect the upper surface to the lower surface, and are opposite to each other,
wherein the covering material is formed by sticking a plurality of insulating films together to surround the upper surface, the first side surface, the lower surface, and the second side surface,
wherein each of the plurality of insulating films includes an inner layer and an outer layer, the inner layer being closer to the conductor than the outer layer,
wherein the lead member includes a first insulator and a second insulator on the first side surface and the second side surface of the conductor respectively, in an area where the covering material surrounds the conductor,
wherein the first insulator and the second insulator have a lower melting point than the inner layer, and
wherein the first insulator and the second insulator are placed to be separated from each other.

2. The lead member as claimed in claim 1, wherein the first insulator and the second insulator contain 40 wt % or greater of polyolefin and have a melting point in a range of 110° C. to 140° C.

3. The lead member as claimed in claim 1, wherein the inner layer contains 40 wt % or greater of polyolefin and has a melting point in a range of 135° C. to 160° C.

4. The lead member as claimed in claim 1, wherein a melting point of the first insulator and the second insulator is in a range of 120° C. to 135° C. and a melting point of the inner layer is in a range of 140° C. to 160° C.

5. The lead member as claimed in claim 1, wherein a size of the conductor in the thickness direction is in a range of 0.1 mm to 3 mm.

6. The lead member as claimed in claim 1, wherein at least either the first side surface or the second side surface of the conductor is processed to have a taper such that a thickness decreases toward an end in the width direction.

7. A package of a secondary battery that is formed by accommodating the secondary battery in an enclosing casing, the package having a lead member a portion of which protrudes from the enclosing casing,
wherein the lead member is electrically connected to an electrode of the secondary battery, and
wherein the lead member is the lead member as claimed in claim 1.

8. A method of manufacturing a lead member for a secondary battery, the method comprising:
a) preparing a conductor having a first surface and a second surface that are opposite to each other, and a third surface and a fourth surface that are opposite to each other and are orthogonal to the first surface and the second surface;
b) placing insulator materials on a portion of the first surface and a portion of the second surface, the insulator materials having an insulating property;
c) placing a first insulating film including a first inner layer and a first outer layer to cover the insulator materials when viewed from the third surface such that the first inner layer faces the third surface when viewed from the third surface;
d) placing a second insulating film including a second inner layer and a second outer layer to cover the insulator materials when viewed from the fourth surface such that the second inner layer faces the fourth surface when viewed from the fourth surface; and
e) welding the first insulating film and the second insulating film to each other at the first surface and at the second surface.

9. The method as claimed in claim 8, wherein the insulator materials have a lower melting point than the first inner layer of the first insulating film and the second inner layer of the second insulating film.

10. A method of manufacturing a lead member for a secondary battery, the method comprising:
a) preparing a first insulating film including a first inner layer and a first outer layer, and a second insulating film including a second inner layer and a second outer layer;
b) placing first insulator materials on portions of the first inner layer in the first insulating film;
c) preparing a conductor having a first surface and a second surface that are opposite to each other, and a third surface and a fourth surface that are opposite to each other and are orthogonal to the first surface and the second surface;
d) placing the first insulating film such that the first inner layer faces the third surface of the conductor when viewed from the third surface, the first insulator materials being placed on a portion of the first surface of the conductor and a portion of the second surface of the conductor;
e) placing the second insulating film such that the second inner layer faces the fourth surface of the conductor when viewed from the fourth surface; and
f) welding the first insulating film and the second insulating film to each other at the first surface and at the second surface.

11. The method as claimed in claim 10, wherein the placing of the first insulator materials includes placing the first insulator materials at two predetermined positions on the first inner layer.

12. The method as claimed in claim 10, wherein the placing of the first insulator materials includes placing second insulator materials at positions on the second inner layer.

13. The method as claimed in claim 10, wherein the first insulator materials have a lower melting point than the first inner layer of the first insulating film and the second inner layer of the second insulating film.

14. The method as claimed in claim 12, wherein the second insulator materials have a lower melting point than the first inner layer of the first insulating film and the second inner layer of the second insulating film.
